(19) United States
(12) Patent Application Publication
(10) Pub. No.: US 2002/0113810 A1
(43) Pub. Date: Aug. 22, 2002

(54) Error and tip information text messaging

(75) Inventors: Roland Radtke, Bellevue, WA (US); David Switzer, Redmond, WA (US)

Correspondence Address: MERCHANT & GOULD PC, P.O. BOX 2903, MINNEAPOLIS, MN, 55402-0903, US

(73) Assignee: Microsoft Corporation

(21) Appl. No.: 09/747,400

(22) Filed: Dec. 22, 2000

(51) Int. Cl. G06F 3/14

(52) U.S. Cl. 345/710; 345/780

(57) ABSTRACT

A method and system are provided for supplying error information and tip information in an accessible and non-interruptive manner by displaying both the error information and the tip information as static text or markers next to a data field into which the user is inputting text. Presentation of the tip information is provided when the user focuses on a given data field. If an error is detected in the data entered by the user, an error marker is placed next to the data field containing the erroneous data. Once the user refocuses on the erroneous field, tip information is once again displayed to assist the user in properly completing the field. The tip information displayed to the user after an error is detected may be tailored to fit the error.

### TECHNICAL FIELD

The present invention relates to provision of error and tip information during data entry. More particularly, the present invention relates to providing error and tip information without disrupting data input workflow.

### BACKGROUND OF THE INVENTION

Computerized forms are increasing in popularity through the use of computer program applications that require a user to complete various data fields such as name, address, telephone numbers, etc. The use of computerized forms is particularly prevalent in electronic commerce where users may order a variety of products and register for a variety of services by completing computerized ordering forms and registration forms. As users complete required data fields in computerized forms, often mistakes are made in completing the forms that prevent the successful submission of the form for processing by a computer application program or by a vendor of products or services to which the user is applying. For example, a user may be required to complete a data field calling for the user's zip code. If the user incorrectly enters the zip code, an error condition results.

Typically, users are alerted to such errors by the presentation of a modal dialog box that overlays the form being completed by the user or—in case of a web-based e-commerce application—by a completely new page containing the error information. Such a modal dialog box or page normally contains a description of the error and often asks the user to resubmit the erroneous information or offers the user help information by allowing the user to select a help button that will cause the presentation of help information to the user. The presentation of the modal dialog box, information page and/or help information overlaying the form being completed by the user interrupts the user's workflow until the user reads the message contained in the dialog box, information page or help file and subsequently dismisses the modal dialog box or information page to return to the form.

In some systems, users are provided information as to how to complete a given data field by presenting the user with a tip when the user focuses over a given data field by hovering the user's mouse pointer over the data field. However, in such systems the tip typically is dynamically presented over the data field and disappears from view when the user begins typing information into the data field. Such presentation of help information disrupts the user's workflow by requiring the user to read the tip information before completing the data field and requires the user to memorize the information contained in the tip given that the tip disappears from view once the user begins entering data into the data field. Moreover, if a mouse is unavailable, tip information cannot easily be accessed by hovering a pointer over the data field.

It is with respect to these considerations and others that the present invention has been made.

### SUMMARY OF THE INVENTION

In accordance with the present invention, the above and other problems are solved by a method and system for providing error information and tip information by displaying both the error information and the tip information as static text or markers next to a data field into which the user is inputting text. An information tip is provided when a user focuses on a given data field and the information tip remains static until the user finishes entering data into the data field. The information tip does not interrupt the user's work flow. If the user enters data erroneously, an error marker alerts the user to the erroneous data field. Once the user refocuses on the marked data field, a second information tip is presented that provides a tip to assist the user in correcting the data entry.

More particularly, the present invention relates to a method and system of displaying a static information tip and an error marker. The method includes focusing on a first data field and displaying a first static information tip proximate to the first data field. Data is entered in the first data field while continuing to display the first static information tip. After entering data in the first data field, the user may focus on a second data field. After the user begins focusing on the second data field, the first static information tip is hidden from view. A determination is made whether the data entered into the first data field is erroneous. If the data entered in the first data field is erroneous, an error marker is placed adjacent to the first data field. After the error marker is placed, the user may refocus on the first data field. After the user refocuses on the first data field, a second static information tip is displayed proximate to the first data field, and the second static information tip contains information for correcting the data entered into the first data field.

These methods may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention, as claimed.

### BRIEF DESCRIPTION OF THE DRAWINGS

FIG. 1 shows a functional block diagram illustrating interaction between an error and tip module and a software application according to an exemplary embodiment of the present invention.

FIG. 2 illustrates a computer system that provides the operating environment for an exemplary embodiment of the present invention.

FIG. 3a depicts an exemplary screen shot used in an exemplary embodiment of the present invention.

FIG. 3b depicts an exemplary screen shot used in an exemplary embodiment of the present invention.

FIG. 3c shows an exemplary screen shot used in an exemplary embodiment of the present invention.

FIGS. 4a and 4b illustrate an exemplary method for displaying information tips and error tips in an exemplary embodiment of the present invention.

### DETAILED DESCRIPTION OF THE INVENTION

In an exemplary embodiment of the present invention, a method and system are provided for supplying error information and tip information in an accessible and non-interruptive manner by displaying both the error information and the tip information as static text or markers next to a data field into which the user is inputting text. Presentation of the tip information is provided when the user focuses on a given data field. During initial entry of data into a given data field, tip information only is provided as a static text display next to the data field. If an error is detected in the data entered by the user, an error marker is placed next to the data field containing the erroneous data. Once the user refocuses on the erroneous field, tip information is once again displayed to assist the user in properly completing the field. In accordance with an exemplary embodiment of the present invention, the tip information displayed to the user after an error is detected may be tailored to fit the error.

For example, if the user focuses on the password field of a data entry page by placing the cursor in that field, in accordance with an exemplary embodiment with present invention, a static tip is presented next the field. The tip may include, for example, an instruction that the password must be at least 1 to 8 characters beginning with a letter. If the user enters an incorrect password into the data field, an error marker such as an “X” may be placed next to the data field after the user changes the focus to a different data field. Accordingly, the error marker next to the password data field will alert the user that the data entered into the password data field was erroneous. The user then may refocus on the password data field and the static tip information will again be displayed next to the data field. The user then will be able to correct the entry in the password data field with the help of the tip information displayed nearby. Therefore, in accordance with the present invention, the tip information and the error information alert the user of erroneous input and provide the user with helpful information for correcting the erroneous input, but do not interrupt the user's workflow by requiring the user to access the tip information or by requiring the user to acknowledge and dismiss an error dialog box.

The present invention may be understood more readily by reference to the following detailed description of the invention and the drawings and their previous and following description.

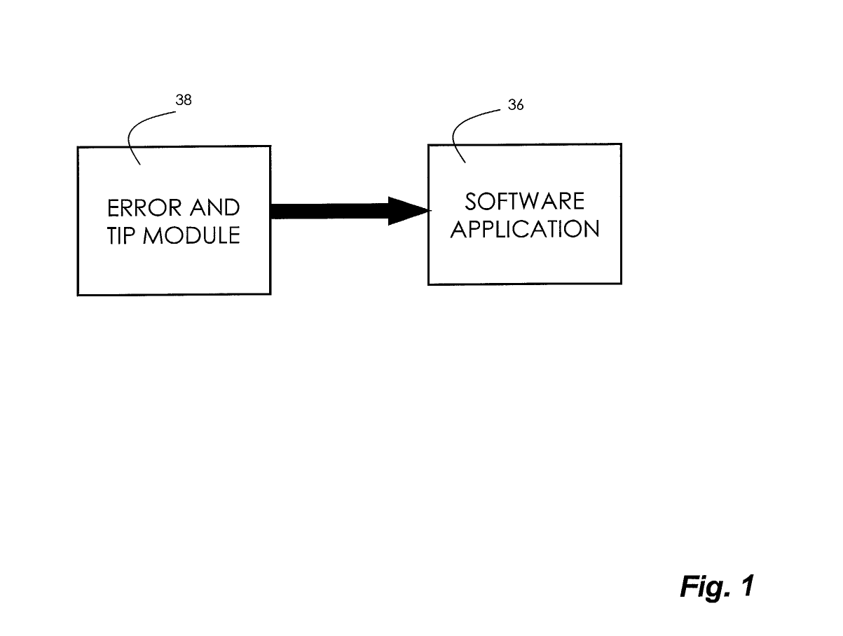

FIG. 1 shows a functional block diagram illustrating interaction between an error and tip module and a software application according to an exemplary embodiment of the present invention. According to an exemplary embodiment, the error and tip module 38 is a program module called upon by the software application 36 to provide error and tip information as discussed above. The application 36 may be any program module including or requiring data fields to be completed by a user of the application. Exemplary applications 36 include familiar online ordering forms and registration forms found on Internet web pages.

According to an exemplary embodiment, the error and tip module 38 includes an array containing Boolean values associated with errors and tips that will be presented to the user as described above. The error and tip module 38 may also include a table that associates errors with a tip window by means of a resource identifier; a data field that is associated with the error such that the data field error may be displayed upon focus on the data field; a resource which contains the text for the error or tip; and a resource identifier which refers to the error marker.

As discussed above, the error and tip information module 38 provides for the display of tip text when the user focuses on a given data field. As is understood by those skilled in the art, Boolean logic may be utilized to provide appropriate tip text according to the circumstances surrounding the focus on the data field (i.e., whether an error is detected and what type of error). By way of example, Table 1 below lists exemplary tip and error text that may be provided for a data field requiring a password entry from a user.

TABLE 1

| | |
|---|---|
| Tip 1 | “The password must be 1-8 characters long and must begin with |
| | a letter. No spaces allowed.” |
| Tip 2 | “The password must be 1-8 characters long.” |
| Tip 3 | “The password must begin with a letter.” |
| Tip 4 | “No spaces allowed.” |
| Error 1 | “X” |
| Error 2 | . . . |

If the user focuses on the password data field, the user may be provided with the text shown for Tip 1 in Table 1. However, if the user enters a password containing the appropriate number of characters and no spaces, but the user erroneously begins the password with a number instead of a letter, contrary to Tip 1, the user may be provided the error marker “X” shown for Error 1 and the tip shown for Tip 3 in Table 1. The presentation of tip and error information may occur automatically by a performing a preset function or manually by the user selecting to start validation, such as with an “OK” or “SUBMIT” button. Each data field may be individually validated or validated in groups.

As should be understood, a variety of tips may be provided. Similarly, a number of different error markers may be used. Such error markers and tips may be displayed in any suitable manner including, but not limited to, displaying in one or more different colors, sounds, and modulating patterns. Selection of a color for error marker or tip text can be done in multiple ways (setting fixed colors, providing color customization, mapping certain background colors or color ranges to specific error colors).

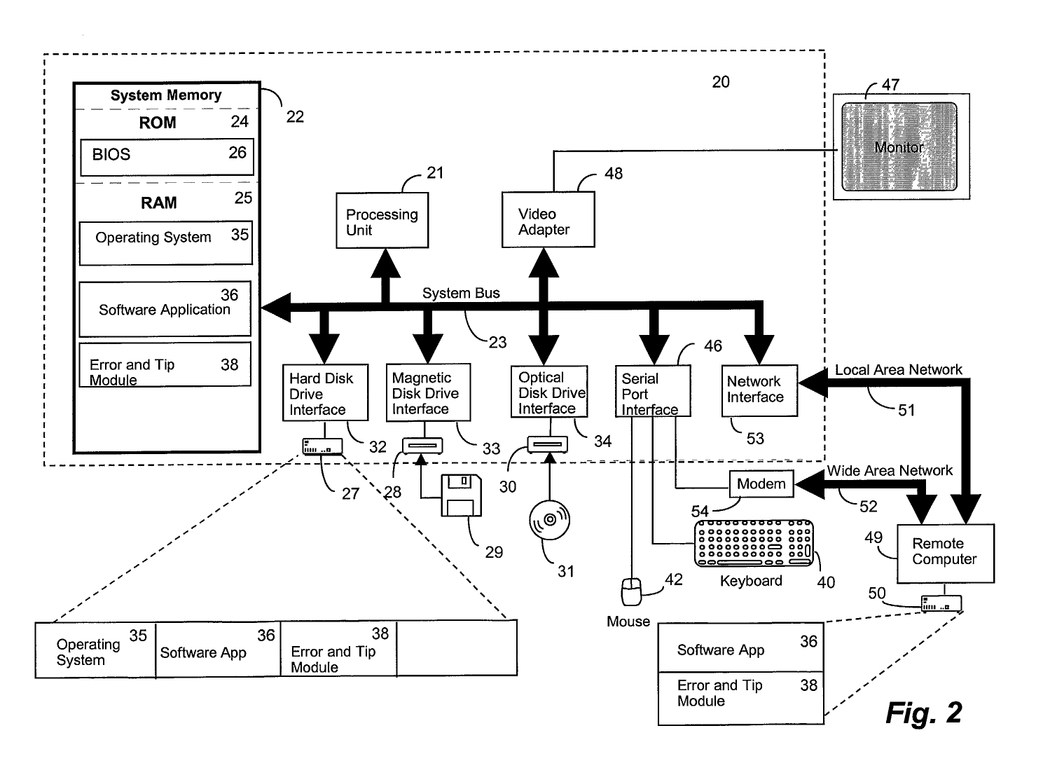

FIG. 2 and the following discussion are intended to provide a brief, general description of a suitable computing environment in which the invention may be implemented. While the invention will be described in the general context of an application program that runs on an operating system in conjunction with a personal computer, those skilled in the art will recognize that the invention also may be implemented in combination with other program modules. Generally, program modules include routines, programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 2, an exemplary system for implementing the invention includes a conventional personal computer 20, including a processing unit 21, a system memory 22, and a system bus 23 that couples the system memory to the processing unit 21. The system memory 22 includes read only memory (ROM) 24 and random access memory (RAM) 25. A basic input/output system 26 (BIOS), containing the basic routines that help to transfer information between elements within the personal computer 20, such as during start-up, is stored in ROM 24. The personal computer 20 further includes a hard disk drive 27, a magnetic disk drive 28, e.g., to read from or write to a removable disk 29, and an optical disk drive 30, e.g., for reading a CD-ROM disk 31 or to read from or write to other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage for the personal computer 20. Although the description of computer-readable media above refers to a hard disk, a removable magnetic disk and a CD-ROM disk, it should be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 25, including an operating system 35, a software application 36, and an error and tip module 38. A user may enter commands and information into the personal computer 20 through a keyboard 40 and pointing device, such as a mouse 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a game port or a universal serial bus (USB). A monitor 47 or other type of display device is also connected to the system bus 23 via an interface, such as a video adapter 48. In addition to the monitor, personal computers typically include other peripheral output devices (not shown), such as speakers or printers.

The personal computer 20 may operate in a networked environment using logical connections to one or more remote computers 49. The remote computer 49 may be a server, a router, a peer device or other common network node, and typically includes many or all of the elements described relative to the personal computer 20, although only a memory storage device 50 has been illustrated in FIG. 2. The logical connections depicted in FIG. 2 include a local area network (LAN) 51 and a wide area network (WAN) 52. Such networking environments are commonplace in offices, enterprise-wide computer networks, intranets and the Internet.

When used in a LAN networking environment, the personal computer 20 is connected to the LAN 51 through a network interface 53. When used in a WAN networking environment, the personal computer 20 typically includes a modem 54 or other means for establishing communications over the WAN 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

Computing device, such as personal computer 20, typically includes at least some form of computer readable media. Computer readable media can be any available media that can be accessed by personal computer 20. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by personal computer 20. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Computer readable media may also be referred to as computer program product.

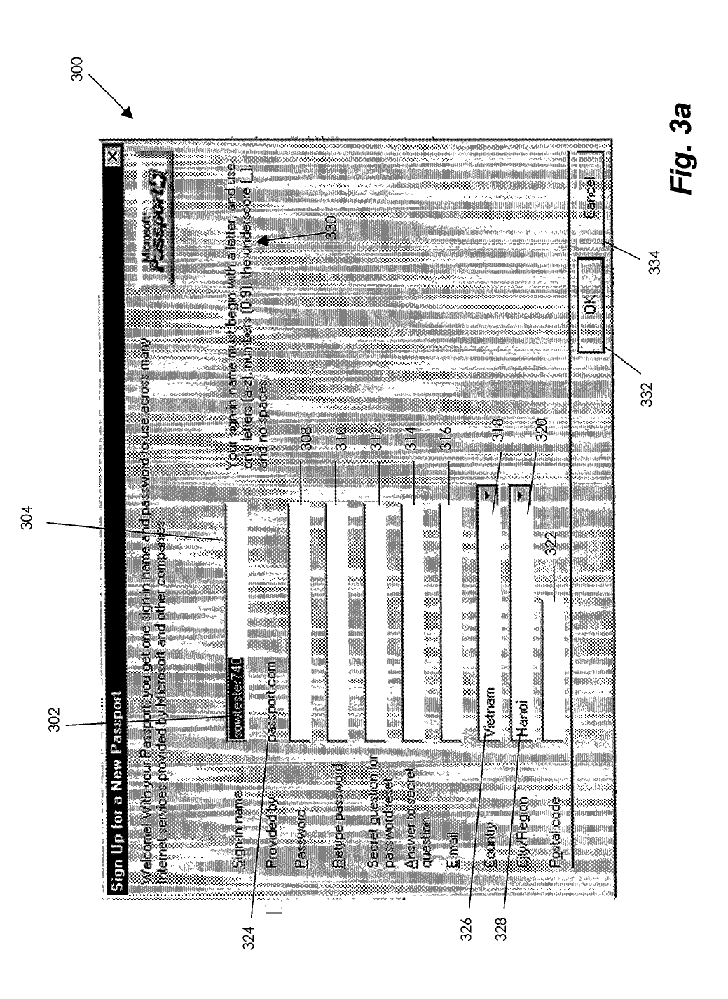

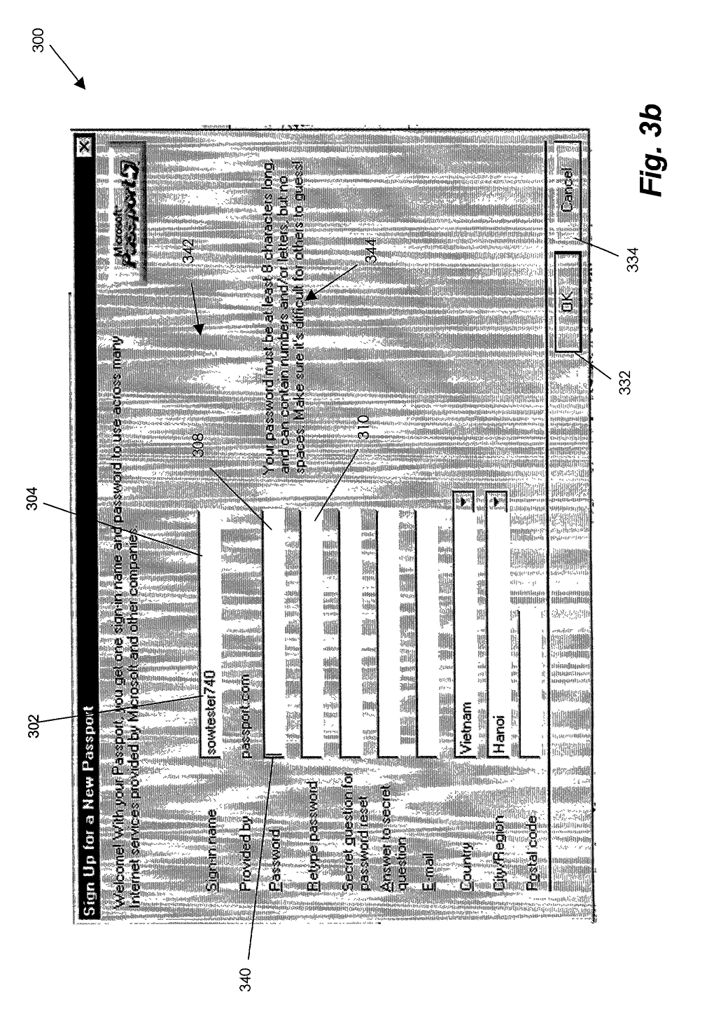

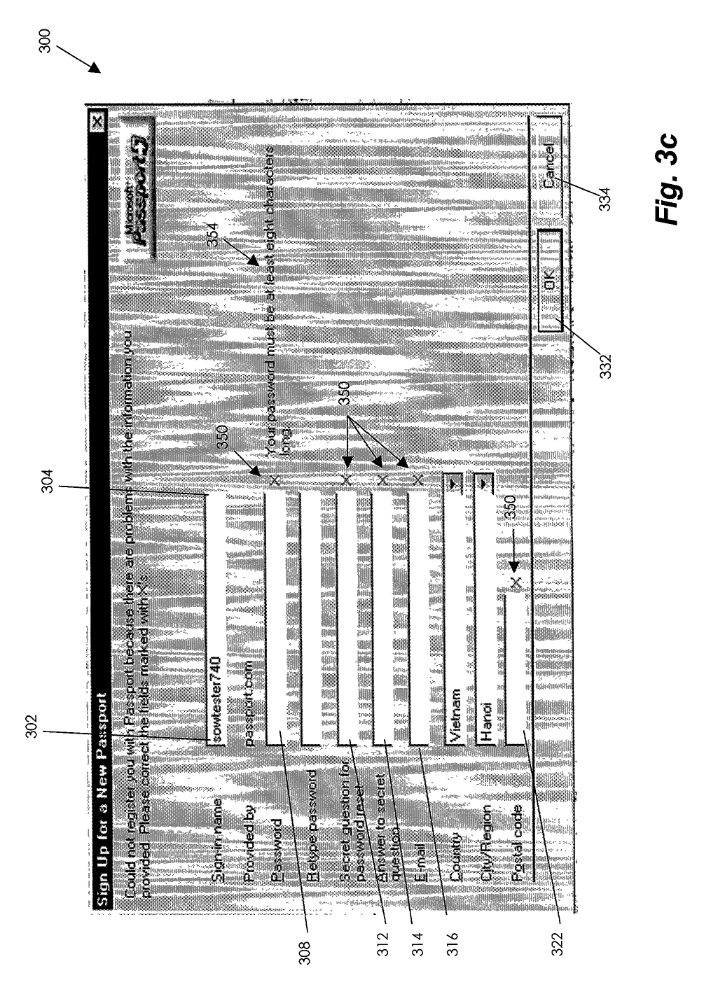

Referring now to FIGS. 3a-3c, exemplary computer screen shots according to an embodiment of the present invention are described with reference to exemplary data input. FIG. 3a depicts an exemplary screen shot of a computer program product, which may be in the format of a form document 300. The form 300 includes a plurality of data fields 304, 308, 310, 312, 314, 316, 318, 320, and 322, including a first data field 304 and a second data field 308.

In accordance with an exemplary embodiment, when the focus is on a data field, a tip 330 that is associated with the data field 304 is displayed to the user. In the embodiment illustrated in FIG. 3a, the tip 330 is displayed proximate to the data field 304. Such a tip 330 may provide information about the rules of the data field or any errors with the associated data field data. The tip 330 may be displayed in any suitable manner including, but not limited to, displaying in one or more different colors, sounds, and modulating patterns. Selection of a color for error marker or tip text can be done in multiple ways (setting fixed colors, providing color customization, mapping certain background colors or color ranges to specific error colors).

The form 300 also includes a validation button 332 and a cancellation button 334. The validation button 332 and cancellation button 334 may be placed anywhere on the form 300. In one embodiment, these buttons 332, 334 are placed at the bottom of the form to encourage data field data entry in the data fields located above the buttons. As shown in FIG. 3b, when the focus 340 is moved to the second data field 308, the first data field tip 330, which is illustrated in FIG. 3a, is hidden from view 342 and a second data field tip 344 is displayed. This ensures that the information displayed at any given time is relevant to the subtask in which the user is engaging. It prevents the problem of information overload, which occurs when a user is not able to discern the relevant information due to the amount of information offered at the same time.

Tips are not limited to the size of the data field, as illustrated by tip 344 in FIG. 3b, which extends into the area proximate to data field 310. As such, the present invention advantageously allows tips to be any size and placed in any location on the form. In the exemplary embodiment of FIG. 3b, the tip 344 is static such that it is displayed as long as the focus remains on the associated data field, the second data field 308. Alternatively, the tip may only be displayed for a predetermined period of time.

After entering data in the appropriate data fields, the user may activate the validation button 332 to submit the form 300, which may activate the error and tip module 38 to determine whether the form 300 contains errors. Alternatively, the user may activate the cancellation button 334 to refrain from submitting the form 300. In another embodiment, the error and tip module 38 may be activated after entering the data field data without use of the validation button 332. In such an embodiment, the validation is entered automatically, such as at the expiration of a preset amount of time or after shifting the focus off of the data field or to a specific data field.

In the exemplary embodiment depicted in FIG. 3c, the user validates the form 300 by activating the validation button 332. In FIG. 3c, several data field entries are determined to be erroneous, which are marked with error markers 350 proximate to the data fields in error 308, 312, 314, 316 and 322. Such error markers 350 are optional, and may be displayed either statically in a continuous fashion, as depicted in FIG. 3c; statically only when the focus is on the associated data field, or for a preset period of time, such as for the time that the pointer is hovering about the associated data field. As with tips, error markers may be displayed using any suitable marker, color, sound, and/or modulating pattern.

The focus may then be moved either automatically or manually (by the user setting the focus) to the data fields in error 308, 312, 314, 316 and 322. Additionally, the form 300 may allow the user to modify data field data that was not identified with a data field in error, such as data 302 in data field 304. As the focus shifts, a data field tip 354 associated with the focused data field, such as the second data field 308, is displayed.

The tip may contain a different message after validation than before validation due to the difference in the data field error state, as described above. For example, the data field tip 354 in FIG. 3c and the data field tip 344 in FIG. 3b both are associated with the same data field, the second data field 308, but each data field tip 354, 344 contains different text. Alternatively, the data field tips may contain the same text message, or a tip may only be available before or after validation. The data field tip may also differ in the manner in which it is displayed by using a variety of colors, sounds, and modulating patterns.

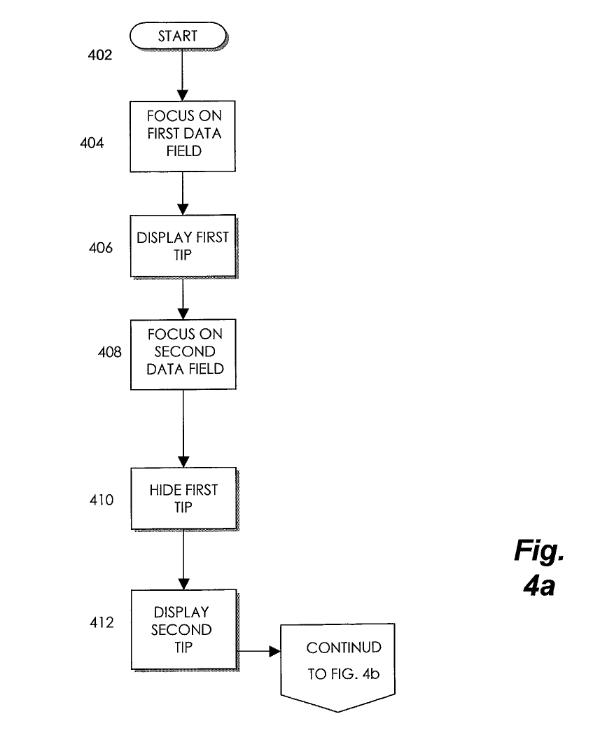

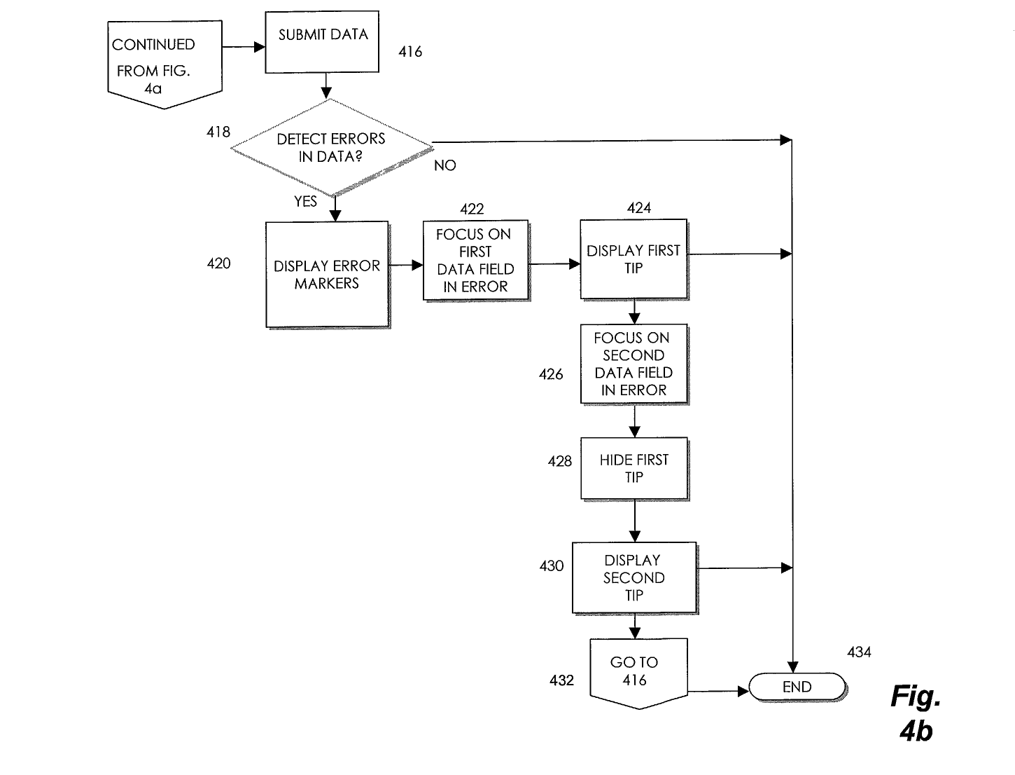

FIGS. 4a and 4b illustrate an exemplary method for displaying tip information and error information in accordance with an exemplary embodiment of the present invention. The flow charts of FIGS. 4a and 4b depict a method of displaying tip and error information as shown in the exemplary screen shots depicted in FIGS. 3a-3c. As shown in the logical flow chart of FIG. 4, the method begins at step 402 and the user focuses on the first data field 304 at step 404. At step 406, the first data field tip 330 is displayed. At step 407, the user enters data into the first data field. At step 408, the focus shifts automatically or manually to the second data field 308, which causes the hiding of the first data field tip at step 410 and the display of the second data field tip 344 at step 412, which may occur in any order including simultaneously.

At step 416, shown in FIG. 4b, the user submits the data entered in data field in the form 300 by selecting the button 332. At step 418, a determination is made whether any of the data submitted in the form 300 was entered in error. If all the data was entered correctly, the method ends at step 434. However, if as with the present example, any of the data fields were completed erroneously, error markers 350 are displayed at step 420, as shown in FIG. 3c.

At step 422, the user focuses on the first erroneously completed data field 308. Once the focus is placed on the data field 308, a tip 354 is displayed adjacent to the data field 308 to assist the user in correcting the data entered in data field 308. If only one error is present, the method may end at step 434. The focus shifts automatically or manually to the next data field(s) in error at step 426 which causes the hiding of the first data field tip 354 at step 428 and the display of a second data field tip at step 430, which may occur in any order including simultaneously. After all data fields initially completed in error have been corrected, at step 432 the method proceeds back to step 416 where the user submits the data. The foregoing steps are repeated until all data fields are completed and submitted successfully.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification be considered as exemplary only, with a true scope and spirit of the invention being indicated by the following claims.

What is claimed is:

1. A method of displaying a static information tip comprising the steps of:
providing a plurality of data fields, wherein the plurality of data fields comprises a first data field and a second data field;
focusing on the first data field;
displaying a first static information tip proximate to the first data field;
focusing on the second data field;
hiding from view the first static information tip; and
displaying a second static information tip proximate to the second data field;
whereby the first static information tip does not interrupt data input into the first data field and whereby the first information tip remains displayed until the step of focusing on the second data field.

2. The method of claim 1, further comprising the steps of:
entering data in the first data field;
determining that the data entered in the first data field is erroneous; focusing on the first data field; and
displaying a third static information tip proximate to the first data field,
whereby the third static information tip does not interrupt corrective data input into the first data field.

3. The method of claim 2, further comprising the steps of:
entering data in the second data field;
determining that the data entered in the second data field is erroneous; focusing on the second data field; and
displaying a fourth static information tip proximate to the second data field,
whereby the fourth static information tip does not interrupt corrective data input into the second data field.

4. The method of claim 2, further comprising the step of:
displaying an error marker proximate to the first data field to indicate the data entered in the first data field is erroneous.

5. The method of claim 3, further comprising the step of:
displaying an error marker proximate to the first and second data fields to indicate the data entered in the first and second data fields is erroneous.

6. A method of displaying a static information tip and an error marker comprising the steps of:
focusing on a first data field;
displaying a first static information tip proximate to the first data field;
entering data in the first data field while continuing to display the first static information tip;
focusing on a second data field;
hiding from view the first static information tip;
determining the data entered into the first data field is erroneous;
placing an error marker adjacent to the first data field;
refocusing on the first data field;
displaying a second static information tip proximate to the first data field, the second static information tip containing information for correcting the data entered into the first data field.

7. A computer readable medium having stored thereon computer-executable instructions which when executed by a computer perform the steps of:
providing a plurality of data fields, wherein the plurality of data fields comprises a first data field and a second data field;
focusing on the first data field;
displaying a first static information tip proximate to the first data field;
focusing on the second data field;
hiding from view the first static information tip; and
displaying a second static information tip proximate to the second data field;
whereby the first static information tip does not interrupt data input into the first data field and whereby the first information tip remains displayed until the step of focusing on the second data field.

8. The medium of claim 7, further comprising the steps of:
entering data in the first data field;
determining that the data entered in the first data field is erroneous;
focusing on the first data field; and
displaying a third static information tip proximate to the first data field,
whereby the third static information tip does not interrupt corrective data input into the first data field.

9. The medium of claim 8, further comprising the steps of:
entering data in the second data field;
determining that the data entered in the second data field is erroneous;
focusing on the second data field; and
displaying a fourth static information tip proximate to the second data field,
whereby the fourth static information tip does not interrupt corrective data input into the second data field.

10. The medium of claim 8, further comprising the step of:
displaying an error marker proximate to the first data field to indicate the data entered in the first data field is erroneous.

11. The medium of claim 9, further comprising the step of:
displaying an error marker proximate to the first and second data fields to indicate the data entered in the first and second data fields is erroneous.

12. A system for displaying a static information tip and an error marker comprising a computer program module operative
to focus on a first data field;
to display a first static information tip proximate to the first data field;
to receive data in the first data field while continuing to display the first static information tip;
to determine the data entered into the first data field is erroneous;
to place an error marker adjacent to the first data field;
to refocus on the first data field;
to display a second static information tip proximate to the first data field, the second static information tip containing information for correcting the data entered into the first data field.
